(19) United States
(12) Patent Application Publication
(10) Pub. No.: US 2008/0222392 A1
(43) Pub. Date: Sep. 11, 2008

(54) Method and arrangements for pipeline processing of instructions

(75) Inventor: Mario Fuchs, Vienna (AT)

Correspondence Address: Alan Carlson, 6202 Lynn Lane, Lago Vista, TX, 78645, US

(73) Assignee: On Demand Microelectronics

(21) Appl. No.: 11/716,153

(22) Filed: Mar. 9, 2007

(51) Int. Cl. G06F 9/32

(52) U.S. Cl. 712/205; 712/234; 712/E09.077

(57) ABSTRACT

In one embodiment a method for parallel processing in a processing pipeline is disclosed. The method can include determining that a jump instruction is loaded in a main path of a processing pipeline prior to the jump instruction being executed. The method can load a jump hit target instruction in a bypass path of the pipeline in response to determining that the jump instruction is loaded in the main path. The bypass path can bypass at least one stage of the processing pipeline and couple into the main path in a stage that is prior to the execute stage. The method can switch the jump hit target instruction into the main path in response to a successful jump-hit condition. The bypass path and the main path can operate concurrently and in parallel.

### FIELD OF THE INVENTION

The invention relates to parallel processing units and to methods and arrangement for operating a processing pipeline with a parallel processor architecture.

### BACKGROUND OF THE INVENTION

Typical instruction processing pipelines in modern processor architectures have several stages and include at least a fetch stage and a decode stage. The fetch stage loads instruction data useable by the instructions (often called immediate values) where the data is passed along with the instructions within the instruction stream. The data and instructions can be retrieved from an instruction memory system and forwarded to a decode stage. The decode stage can expand and split the instructions assigning portions or segments of the total instruction to individual processing units and passes the segments to the execution stage.

One advantage of instruction pipelines is that the complex process of instruction processing like accessing the instruction memories, fetching the instructions, decoding and expanding of instructions, analyzing whether data is scheduled to be written to registers in parallel while other instructions use it, executing the instructions, or writing of results back to memories or to register files can be broken up in separate stages which execute concurrently. Each stage performs a task, e.g., the fetch stage fetches instructions from an instruction memory system. Therefore, pipeline processing enable a system to process a sequence of instructions, one instruction per stage concurrently to improve processing power due to the concurrent operation of all stages. In a pipeline environment in one clock cycle one instruction can be fetched by the fetch stage, whilst another is decoded in the decode stage, whilst another instruction is be executed in the execute stage. Therefore, in a pipeline environment each instruction needs three processor cycles to propagate through a three-stages pipeline and to be processed in each of the three stages (i.e. one clock cycle for each fetch, decode and execute), assuming one cycle per stage. However, in a pipeline configuration while an instruction is being processed by one stage, others stages are concurrently processing.

Therefore, generally, one instruction can be executed by an execute stage each clock cycle. The more stages the instruction processing task can be broken into the faster each stage can operate. Higher clock frequencies can be achieved if the stages can operate faster and hence the system can operate faster. It is a pursuit of designers to design a pipeline with smaller and faster stages even though the pipeline itself may be longer.

In pipeline processing, jump conditions can occur, where the instruction stream is not continuous and instructions must be locate and loaded into the pipeline because of the jump and the pipeline processing is interrupted. The earlier in the pipeline a jump can be detected the quicker the system can react to the break in the instruction chain and hence the smaller latency on the pipeline. On the other hand, if a jump is detected very late in the pipeline, each previous stage has to stall (or be idle) until instructions from the new instruction address(es) requested by the jump condition are loaded to these stages. As instructions are processed sequentially in a pipeline, the reload of the pipeline due to a jump can take several clock cycles. In the case of a jump, generally very long instruction pipelines are less flexible than short pipelines.

Two basic approaches are utilized to prevent a pipeline from stalling in case of a jump. One approach is to completely decouple the fetching of instructions from the pipeline. Whenever a jump occurs, the decoupled fetching system reads the new instructions—the so-called jump-target—from the new address and feeds the instructions starting with the jump-target to the pipeline. One disadvantage with this approach is that conditional jumps are not possible in such designs. A conditional jump is a jump which is only performed in case a certain condition evaluates to true. Such an evaluation typically can only be performed by the execute stage which is typically located in the middle of the pipeline. Another approach is to try to detect a jump very early in the pipeline and this approach has similar disadvantages. In modern processor architectures, jumps typically are detected in the execute stage which offers the highest flexibility, however this arrangement has the drawback that all previous stages would have to stall in case of a jump.

### SUMMARY OF THE INVENTION

In one embodiment, a method for parallel processing is disclosed. The method can include determining that a jump instruction is loaded in a main path of a processing pipeline prior to the jump instruction being executed. The method can load a jump-hit target instruction in a bypass path of the pipeline in response to determining that the jump instruction is loaded in the main path, where the bypass path bypasses at least one stage of the processing pipeline and couples into the main path in a stage that is prior to the execute stage. The method can switch the jump hit target instruction into the main path in response to a successful jump-hit condition. The bypass path and the main path can operate in parallel.

In one embodiment the method can fetch instruction data associated with the instruction and bypassing the decode stage with the instruction data to save clock cycles. In another embodiment the instruction can bypass a fetch stage. The forward stage can be located before the execute stage. The forward stage or another stage could identify the jump instruction prior to the instruction entering the execute stage. The coupling into the main path can occur at the decode stage, the forward stage, or the execute stage.

In another embodiment, an apparatus is disclosed. The apparatus can include a fetch module, an execute module, a jump instruction detector and a jump instruction fetch module. The fetch module can fetch an instruction to a pipeline, the decode module can decode the instruction, and the execute module can execute the instruction. The jump instruction detector can detect a jump condition in the pipeline prior to the jump instruction being executed, and the jump instruction fetch module can retrieve and load a jump-hit instruction in response to the jump instruction detector. The jump instruction fetch module can move the jump fetch instruction to a middle stage of the pipeline, bypassing stages in the pipeline. The apparatus can also include a forward module coupled to the execute module to control an input to the execute module. In another embodiment the apparatus can include a switch to switch the jump-hit instruction into the pipeline at a execute stage or a forward stage or a decode stage in response to a successful jump-hit. The jump-hit instruction bypasses the fetch module. In one embodiment a fetch stage can fetch instruction data associated with the jump instruction and the instruction data can bypass the decode stage.

In another embodiment, a computer program product is disclosed. The product can include a computer useable medium having a computer readable program, wherein the computer readable program when executed on a computer causes the computer to determine that a jump instruction is loaded in a main path of a processing pipeline prior to the jump instruction being executed. The computer can also load a jump hit target instruction in a bypass path of the pipeline in response to the determining that the jump instruction is loaded in the main path, the bypass path bypassing at least one stage of the processing pipeline and coupling into the main path in a stage that is prior to the execute stage, and switch the jump hit target instruction into the main path in response to a successful jump-hit condition.

### BRIEF DESCRIPTION OF THE DRAWINGS

In the following the disclosure is explained in further detail with the use of preferred embodiments, which shall not limit the scope of the invention.

FIG. 1 is a block diagram of a pipeline architecture having a bypass path and a main path for instruction processing and a bypass path for the decode stage;

FIG. 2 is a block diagram of a processor architecture having parallel processing modules;

FIG. 3 is a block diagram of a processor core having a parallel processing architecture;

FIG. 4 is a processor pipeline consisting of a coupled instruction cache pipeline and an instruction processing pipeline having a fetch/decode stage;

FIG. 5a depicts fetching and decoding of instructions and immediate values in conventional architectures;

FIG. 5b depicts fetching and decoding of instructions and immediate values in a combined fetch/decode stage;

FIG. 6 shows the relevant stages of FIG. 4 in more detail;

FIG. 7 shows an example of a processor instruction having instruction words and immediate words;

FIG. 8 is a block diagram of an instruction stream buffer module which uses instruction line buffers;

FIG. 9 depicts combined fetching and decoding of instructions in a regular program flow;

FIG. 10 depicts combined fetching and decoding of instructions in case of a jump-miss;

FIG. 11 depicts combined fetching and decoding of instructions in case of a jump-hit;

FIG. 12 shows a block diagram of an instruction cache pipeline;

FIG. 13 shows a top-level block diagram of a combined fetch/decode stage;

FIG. 14 shows a block diagram of an expander module including logic elements only;

FIG. 15 shows a block diagram of an expand-decoder module having logic elements and registers;

FIG. 16 shows a flow diagram for offset fetching and decoding of instructions.

FIG. 17 shows a flow diagram for handling a jump-hit condition.

### DETAILED DESCRIPTION OF THE PREFERRED EMBODIMENTS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims. The descriptions below are designed to make such embodiments obvious to a person of ordinary skill in the art.

While specific embodiments will be described below with reference to particular configurations of hardware and/or software, those of skill in the art will realize that embodiments of the present disclosure may advantageously be implemented with other equivalent hardware and/or software systems. Aspects of the disclosure described herein may be stored or distributed on computer-readable media, including magnetic and optically readable and removable computer disks, as well as distributed electronically over the Internet or over other networks, including wireless networks. Data structures and transmission of data (including wireless transmission) particular to aspects of the disclosure are also encompassed within the scope of the disclosure.

In one embodiment, methods, apparatus and arrangements for executing instructions utilizing multi-unit processors that can execute very long instruction words (VLIW)s are disclosed. The processor can have a plurality of modules which can operate in a plurality of one or more stages of a pipeline.

In the disclosed methods and architectures for fetching and decoding of instruction words and immediate words (alternately called instruction data) in a processor using N parallel processing units is provided. In each processor cycle the processor can execute one processor instruction. A processor instruction can consists of an instruction word group and an immediate word group containing a variable number of immediate values corresponding to the instructions of the instruction word group. Each instruction word can have zero, one, or several immediate values. In each processor cycle the processor can decode the current instruction words and can fetch the current immediate words and the next immediate words.

In case of a jump-hit the instruction cache system can extract the jump-target instruction(s) directly from the appropriate cache-lines and can bypass them to the decode stage whilst in parallel the fetch stage can fetch a next instruction word group and the immediate values which belong to the jump-target instructions.

One advantage of the method and apparatus of the present disclosure is that at least one cycle can be saved in case of a jump-hit compared to conventional solutions. Moreover, the clear structure of the processor instruction combined with a fetching of instruction groups and their assigned immediate values can reduce the complexity of the fetch stage, save chip area, and speed up the fetching task and the entire process.

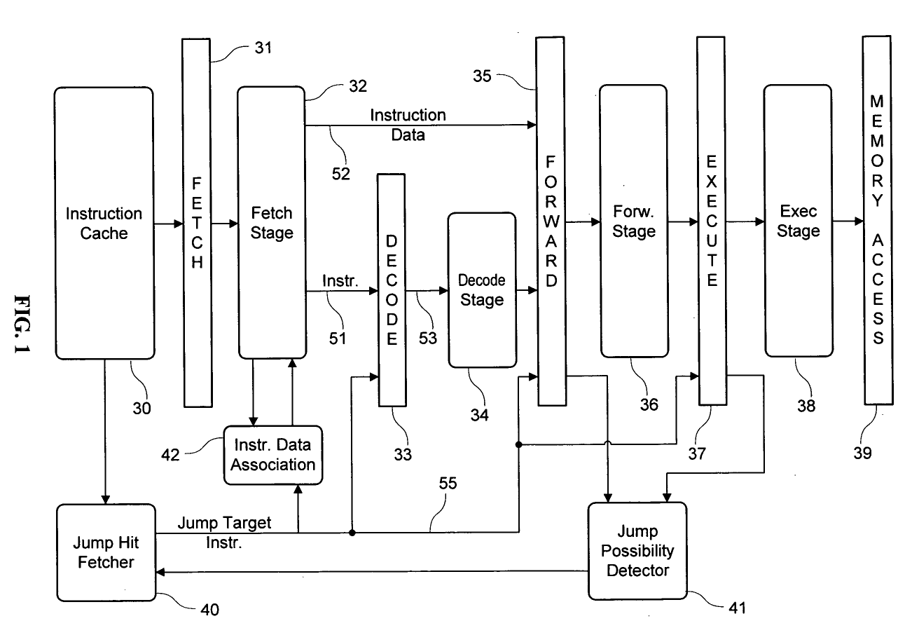

FIG. 1 shows a pipeline architecture according to the disclosure. The pipeline can consist of an instruction cache 30, which can cache the instructions of an external memory, and can forward the instructions to buffer 31. The pipeline can contain a fetch stage 32 which can fetch instructions and instruction data from the buffer 31. An instruction can be loaded in a register with instruction data, where the instruction data, can be a numerical value.

In operation, in one clock cycle, the fetch stage 32 can fetch an instruction 51 and can write it to a decode register 33. The pipeline also can contain a decode stage 34 which can decode the instruction in a second clock cycle. Whilst the instructions 53 are decoded (in the same clock cycle), the fetch stage can fetch instruction data 52 associated with the instruction 53 being decoded. In other words, in a first clock cycle, the fetch stage 32 can fetch an instruction and in a second cycle the decode stage 34 can decode the instruction 53 while the fetch stage 32 can fetch instruction data 52 associated with the instruction 53. The association module 42 can associate the instruction data 52 with the instruction 53 it belongs to as these operations are performed in different clock cycles. The decoded instruction 53 and the fetched instruction data 52 can be written to a forward register 35.

The forward stage 36 can read data from a forward register 35 and from other modules to provide execution data in a register 37 for the execute stage 38. The execute stage 38 can consist of a multitude of parallel processing units which each can read instructions and data from the execute register 37. The parallel processing units can access a common register file or can access their own registers which are not shown in the FIG. 1.

In case of a jump, instructions beginning from a new position in the instruction memory may need to be loaded. The instruction at the new position, i.e., the instruction at the jump address, is called jump-target. In some embodiments of the disclosure, jumps in the instruction stream processed in the main pipeline can be detected by a jump possibility detector 41 which can receive signals from registers 35 and/or 37 and/or from the modules 36 and/or 38 and which can send a jump signal to a jump-hit fetcher 40. In the event that the instructions at the jump address are stored in cache 30, (i.e., in case of an instruction cache hit—a so-called jump-hit) a jump-hit fetcher 40 can directly extract a jump target instruction 55 from the cache system 30 and can send the jump target instruction 55 to the decode register 33 bypassing the fetch stage 32. In another embodiment, the jump-hit fetcher 40 can have an additional functionality and the jump-hit fetcher 40 can send the jump target instruction 55 to a forward register 35, and/or an execute register 37. A smaller stage also allows faster clocking. This procedure can save one cycle in case of a jump-hit as explained below in more detail. Hence, the blocks 30, 40, 33 can define a bypass path for the jump target instruction 55 in parallel to the main path of the main pipeline shown by the blocks 30, 31, 32 and 33. In case of a jump-hit, the association module 42 can associate the instruction data to the jump target instruction with a pointer or other relational method. Thus the instruction data can bypass a decode stage and a jump instruction can bypass a fetch stage providing substantial benefit to pipeline operation.

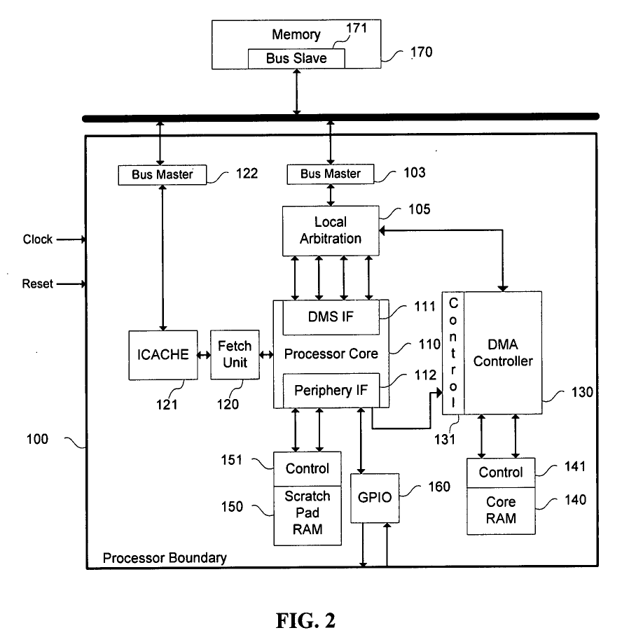

FIG. 2 shows a block diagram overview of a processor 100 which could be utilized to process image data, video data or perform signal processing, and control tasks. The processor 100 can include a processor core 110 which is responsible for computation and executing instructions loaded by a fetch unit 120 which performs a fetch stage. The fetch unit 120 can read instructions from a memory unit such as an instruction cache memory 121 which can acquire and cache instructions from an external memory 170 over a bus or interconnect network.

The external memory 170 can utilize bus interface modules 122 and 171 to facilitate such an instruction fetch or instruction retrieval. In one embodiment the processor core 110 can utilize four separate ports to read data from a local arbitration module 105 whereas the local arbitration module 105 can schedule and access the external memory 170 using bus interface modules 103 and 171. In one embodiment, instructions and the data are read over a bus or interconnect network from the same memory 170 but this is not a limiting feature, instead any bus/memory configuration could be utilized such as a “Harvard” architecture for data and instruction access can be utilized.

The processor core 110 could also have a periphery bus which can be used to access and control a direct memory access (DMA) controller 130 using the control interface 131, a fast scratch pad memory over a control interface 151, and to communicate with external modules, a general purpose input/output (GPIO) interface 160. The DMA controller 130 can access the local arbitration module 105 and read and write data to and from the external memory 170. Moreover, the processor core 110 can access a fast Core RAM 140 to allow faster access to data. The scratch pad memory 150 can be a high speed memory that can be used to store intermediate results or data which is frequently utilized. The fetch and decode method and apparatus according to the disclosure can be implemented in the processor core 110.

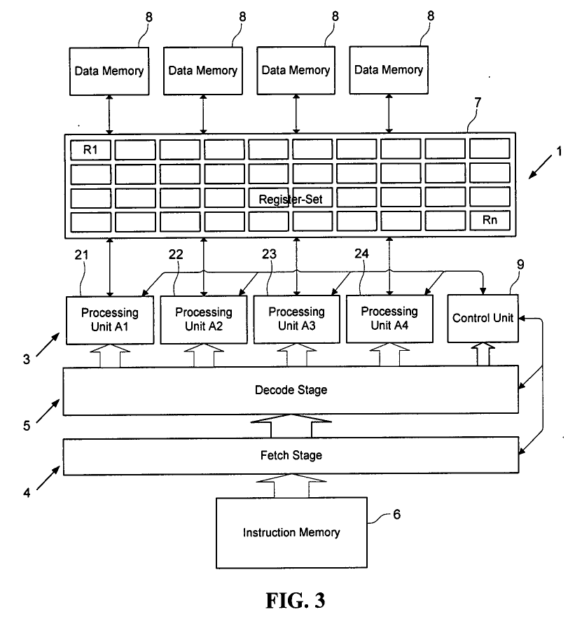

FIG. 3 shows a high-level overview of a processor core I which can be part of a processor having a multi-stage instruction processing pipeline. The processor I shown in FIG. 3 can be used as the processor core 110 shown in FIG. 2. The processing pipeline of the processor core 1 is indicated by a fetch stage 4 to retrieve data and instructions, a decode stage 5 to separate very long instruction words (VLIWs) into units, processable by a plurality parallel processing units 21, 22, 23, and 24 in the execute stage 3. Furthermore, an instruction memory 6, can store instructions and the fetch stage 4 can load instructions into the decode stage 5 from the instruction memory 6. The processor core 1 in FIG. 3 contains four parallel processing units 21, 22, 23, and 24. However, the processor core can have any number of parallel processing units which can be arranged in a similar way.

Further, data can be loaded from or written to data memories 8 from a register area or register set 7. Generally, data memories can provide data and can save the results of the arithmetic proceeding provided by the execute stage. The program flow to the parallel processing units 21-24 of the execute stage 3 can be influenced for every clock cycle with the use of at least one control unit 9. The architecture shown provides connections between the control unit 9, processing units, and all of the stages 3, 4 and 5.

The control unit 9 can be implemented as a combinational logic circuit. It can receive instructions from the fetch 4 or the decode stage 5 (or any other stage) for the purpose of coupling processing units for specific types of instructions or instruction words for example for a conditional instruction. In addition, the control unit 9 can receive signals from an arbitrary number of individual or coupled parallel processing units 21-24, which can signal whether conditions are contained in the loaded instructions.

Typical instruction processing pipelines known in the art have a fetch stage 32 and a decode stage 34 as shown in FIG. 1. The parallel processing architecture of FIG. 3 which is an embodiment of the present disclosure has a fetch stage 4 which loads instructions and immediate values (data values which are passed along with the instructions within the instruction stream) from an instruction memory system 6 and forwards the instructions and immediate values to a decode stage 5. The decode stage expands and splits the instructions and passes them to the parallel processing units.

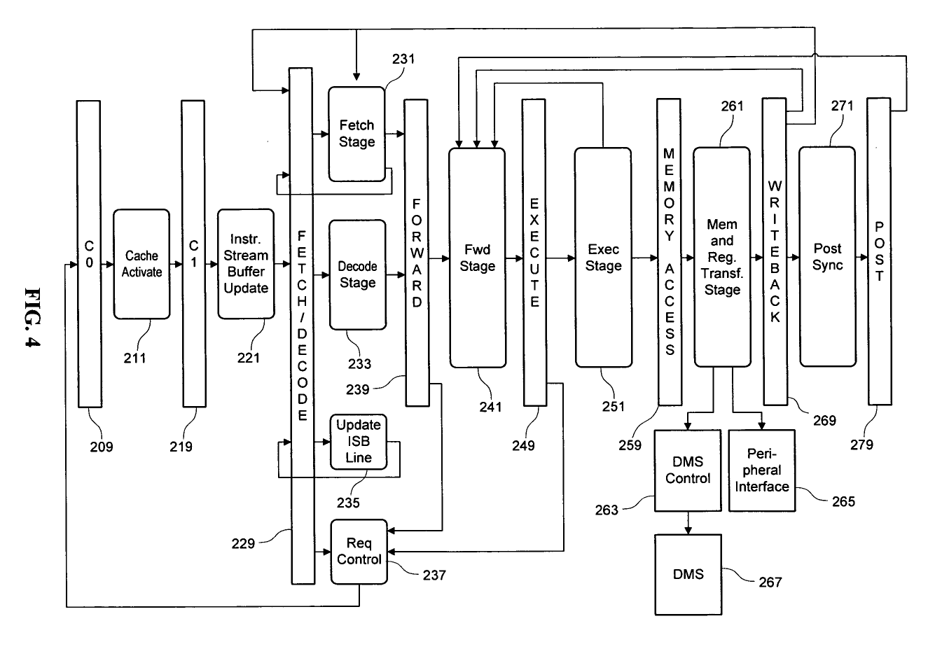

FIG. 4 shows in another embodiment of the present disclosure a pipeline in more detail which can be implemented in the processor core 110 of FIG. 2. The vertical bars 209, 219, 229, 239, 249, 259, 269, and 279 denote pipeline registers. The modules 211, 221, 231, 233, 235, 237, 241, 251, 261, and 271 can read data from a previous pipeline register and may store a result in the next pipeline register. Modules with a pipeline register forms a pipeline stage. Other modules may send signals to no, one, or several pipeline stages which can be the same, one of the previous, one of the next pipeline stages.

The pipeline shown in FIG. 4 can consist of two coupled pipelines. One pipeline can be an instruction processing pipeline which can process the stages between the bars 229 and 279. Another pipeline which is tightly coupled to the instruction processing pipeline can be the instruction cache pipeline which can process the steps between the bars 209 and 229.

The instruction processing pipeline can consist of several stages which can be a fetch-decode stage, a forward stage 241, an execute stage 251, a memory and register transfer stage 261, and a post-sync stage 271. It is characteristic to the disclosure, that the fetch and the decode modules 231 and 233 are combined in one fetch-decode stage. The fetch-decode stage, hence, performs the fetch stage and the decode stage. The fetch stage 231 can write the fetched instructions back to the fetch/decode register 229 and writes the immediate values to the forward register 239. The decode stage 233 can read the fetched instructions from the fetch/decode register 229 and or from the fetch stage 231 and can write the decoded instructions to the forward register 239.

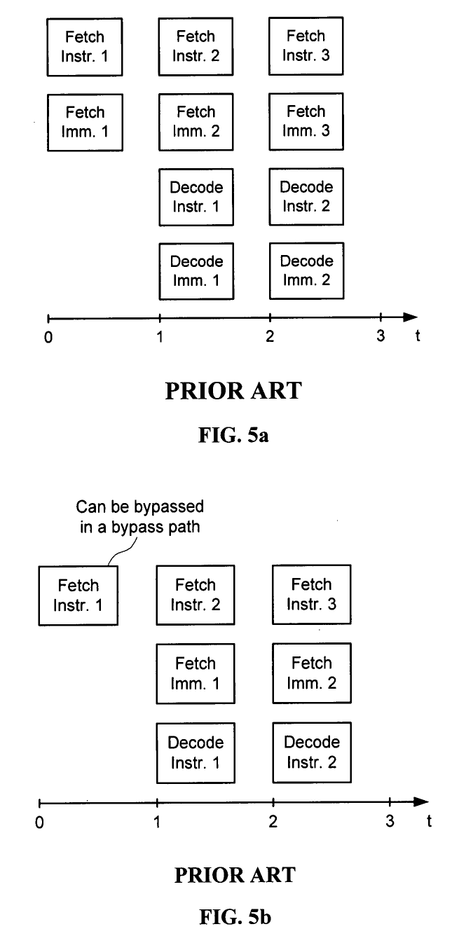

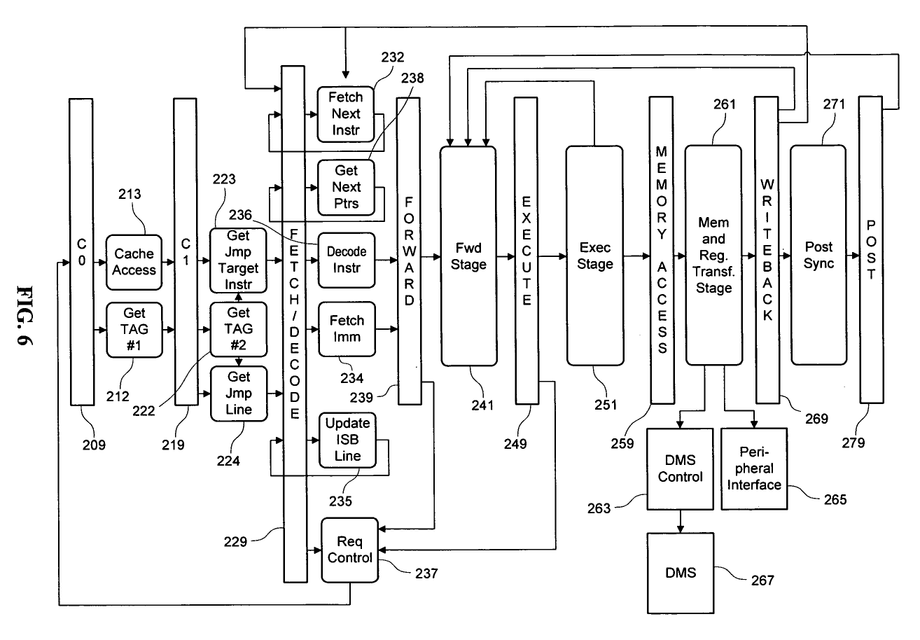

FIG. 5a shows processing of fetch and decode stages in a conventional or prior art pipeline. At time step 0 the first instructions 1 and the immediate values 1 which can be passed along with the instructions 1 are fetched. The instructions can have one instruction for each processing unit. The immediate values can be associated to the instructions. At time stamp 1 the instructions 2 and the immediate values 2 which are passed along with the instructions 2 are fetched. Moreover, the instructions 1 and the immediate values 1 are decoded. At time stamp 2 the instructions 3 and the immediate values 3 which are passed along with the instructions 3 are fetched. Moreover, the instructions 2 and the immediate values 2 are decoded.

FIG. 5b shows processing utilizing a combined fetch and decode stage according to the disclosure. At time step 0 the instructions 1 are fetched only. At time stamp 1 the instructions 2 and the immediate values 1 are fetched and the instructions 1 are decoded. At time stamp 2 the instructions 3 and the immediate values 2 are fetched and the instructions 2 are decoded. It is to note, that no decoding is applied on immediate values as they do not require any processing in a decoding step. Conventional pipeline architectures require a decoding step for immediate values and thereby simply store the immediate values in registers. It is one of the advantages of the present disclosure, that the number of tasks performed by the fetch and decode stages are reduced compared to conventional pipeline designs. According to the embodiment the instruction 1 at time step 0 can be bypassed in a bypass path.

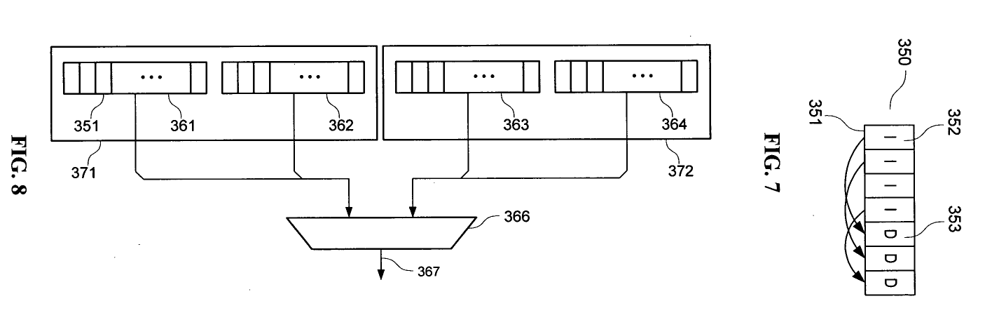

FIG. 6 shows a processing pipeline similar to that of FIG. 4 with more detail. As shown in FIG. Sb immediate values need not to be decoded. In FIG. 5b at time step 0 the instructions 1 can be fetched. In FIG. 6 this can be done by the module 232, which can fetch the instructions and can write them back to the fetch/decode register 229. At the next cycle (at time step 1) in FIG. 5b the instructions 1 can be decoded while the immediate values 1 and the instructions 2 can be fetched. In FIG. 6 the module 236 can decode and split these instructions I and can write the decoded instructions to the forward register 239. The module 234 can fetch the immediate values 1 and can write them to the forward register 239. The module 232 can read the next instructions (instructions 2 according to FIG. 5b) and can write them back to the fetch/decode register 229. The following instructions and immediate values can be handled in the same way. As a conclusion, instructions can be fetched in a first processor cycle from the fetch/decode register block 229 and can be written to this register; in a next processor cycle the instructions can be decoded and immediate values can be fetched and the decoded instructions and the fetched immediate values can be written to the forward register 239.

The module 241 or the decode stage 233 of FIG. 4 can detect, whether a value is used in the next processor cycle for execution in the execution stage 251 that shall be written to a register or memory address within one of the next processor cycles. This is the case when a value shall be stored to a register or a memory address that is read in one of the next cycles. The transfer of values from the execute stage to registers or to or from the memory can take several cycles. Therefore, if a value that shall be written to a register or a memory address has not been stored yet but is heading there, the forward stage can provide the values for the next executions.

The module 251 of FIG. 4 and FIG. 6 forms at least part of the execute stage and enables execution of instructions in a plurality of processing units which can be controlled in a single-instruction-multiple-data (SIMD) or a multiple-instruction-multiple-data (MIMD) mode or any combination thereof. The module 251 can write results to an execute-register 259.

In one embodiment, the module 261 of FIG. 4 and FIG. 6 can form the memory and register transfer stage. The memory and register transfer stage 261 can be responsible to write values to one or more register files, one or more periphery interfaces 265, one or more data memory subsystems (DMS) 267 using a DMS control module 263 whereas the DMS 267 can perform the access to external or/and internal memories, or other memories. In other embodiments the module 261 can be merged with other pipeline stages or be broken up to several pipeline stages.

The module 271 of FIG. 4 and FIG. 6 forms the post sync stage which can hold values which are written to a register or a memory stage in one of the pipeline stages before and can provide the values to the forward stage. In other embodiments the post sync stage can be omitted, can be merged with other stages or can be broken up into several stages. Moreover, other embodiments may have additional pipeline stages which bring in different functionalities which are not discussed here as they do not contribute to the disclosure.

As explained above, the processor core 1 shown in FIG. 3 can be one embodiment of the processor core 110 of FIG. 2. However, the processor core 110 can contain a multitude of parallel processing units which execute instructions in parallel. In the embodiment shown in FIG. 3, the processor core has the four processing units 21, 22, 23, and 24. In one embodiment, each processing unit can receive instructions and immediate values from the pipeline indicated by the stages 4 and 5. In another embodiment, the parallel processing units can receive instructions and immediate values from the forward stage 241 according to FIG. 6.

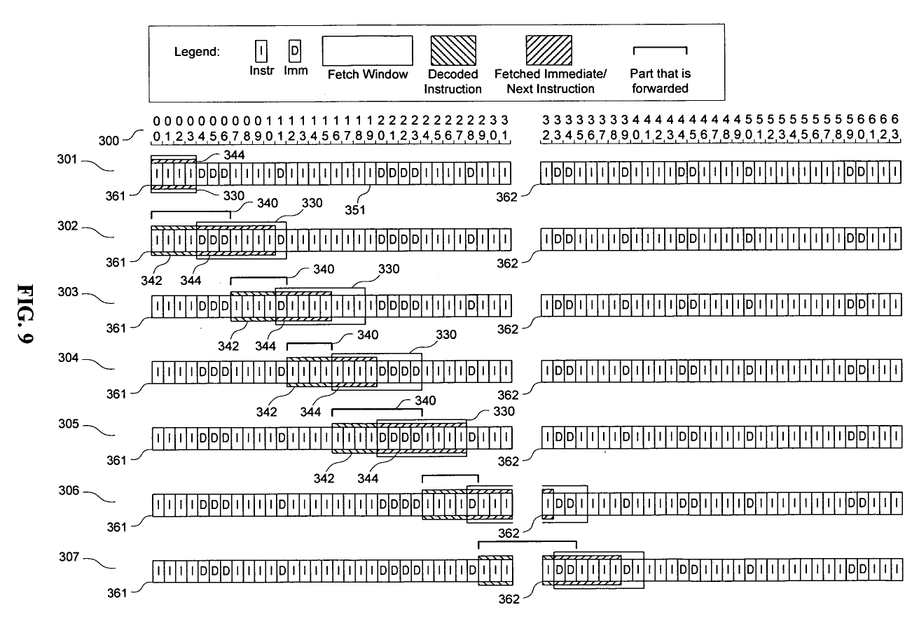

FIG. 7 shows a processor instruction 350 that can advance to the processor core 110 of FIG. 2. The processor instruction 350 consists of several words 351. A processor instruction 350 can contain instructions for the processing units and no or a multitude of immediate values which are necessary to execute these instructions. In fact there can be more immediate value than instructions. In the example shown in FIG. 7 the processor instruction 350 consists of four instruction words 352 labeled with an “I” (one instruction for each of the processing units 21, 22, 23, and 24) and three immediate words 353 denoted with a “D” (for data) which hold immediate values. The arrows indicate which of the immediate words 353 in this example are associated with, or linked to the instruction word(s) 352. In the embodiment explained each instruction word 352 can have zero or one immediate values 353. An example for an instruction to a processing unit that takes one immediate value can be: R1<<2 which shifts the register R1 to the left by two. In this example the instruction is “R1 shift left” and the immediate value is 2. An example for an instruction to a processing unit that does not need an immediate value can be: inc(R1) which increments the register R1. It is to note, that in other embodiments, each instruction word 352 can have an arbitrary number of immediate words 353. In one embodiment, the immediate word(s) 353 can be associated with the instruction word(s) 352 by coding in the instruction word(s) 352. In other embodiments this information can be provided from other sources.

However, it is characteristic to the disclosure that the instruction words 352 are grouped to instruction word groups. The immediate words 353 are grouped as well. The immediate word groups can be located after the instruction word groups 352 within the processor instruction 350. Grouping of instruction and immediate words in this disclosure means that the words of a type are arranged one after the other in order. In embodiments of the disclosure an additional or a dedicated instruction word can store global instructions which are used to control the processor 100. In other embodiments of the disclosure certain bits of each instruction word can be used for controlling purposes or global instructions to the processor 100.

The processor core 110 can contain a number of so-called instruction line buffers. FIG. 8 shows the instruction line buffers 361, 362, 363, and 364. Each instruction line buffer can have a similar number of words 351 whereas the words can be instruction words 352 or immediate words 353. The instruction lines can hold parts of the program which are in execution. Two instruction line buffers can form a so-called instruction stream buffer. In FIG. 8 the instruction line buffers 361 and 362 forms the instruction stream buffer 371 and the instruction line buffers 363 and 364 form the instruction stream buffer 372. It is to note that an instruction stream buffer can also contain additional logic or registers which are not drawn here. The switching logic 366 can be used to select the active instruction stream buffers 367 from the instruction stream buffers 371 and 372. One instruction stream buffer can hold a part of the program which is in execution. This instruction stream buffer is called active instruction stream buffer. In case of a jump or conditional jump other instruction stream buffers could be used and can be filled with the processor instructions at the jump address. The jump-target is the instruction word group at the jump address of a jump or conditional jump. However, the disclosure is not limited to any number of instruction stream buffers or instruction line buffers.

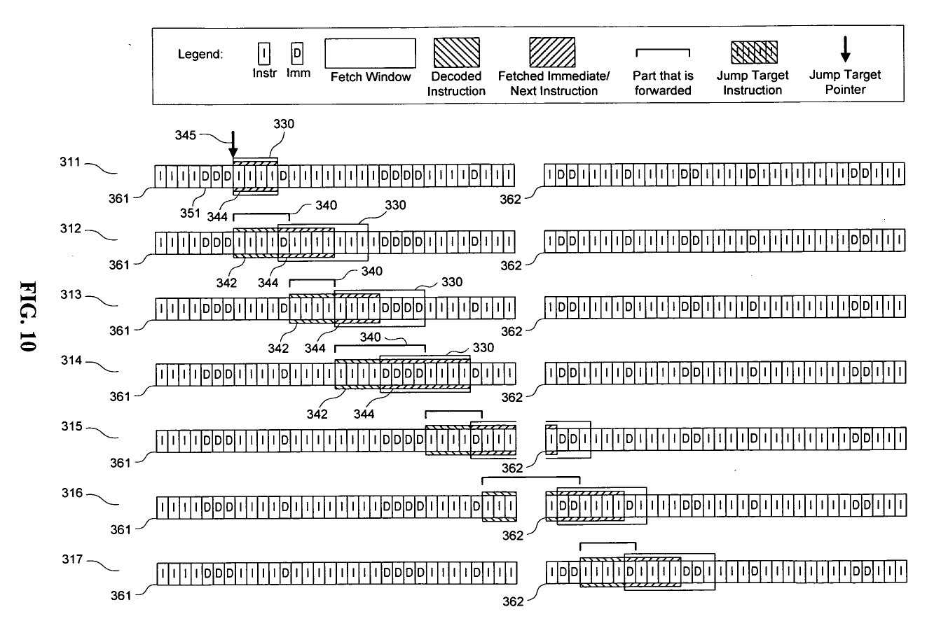

FIG. 9 shows the execution of commands in an active instruction stream buffer according to the present disclosure. For the example of FIG. 9 the instruction stream buffer 371 was chosen as an active instruction stream buffer. The instruction stream buffer shown can consist of two instruction line buffers 361 and 362 which are filled with a program sequence. The case in FIG. 9 shows the situation after a reset or a jump-miss to an address which points to the first word of the instruction line buffer 361. A jump-miss is described later in the description.

As described above, each of the processing units can execute one instruction per processor cycle. In the example of FIG. 9 four processing units as shown in FIG. 3 are used. Each of the four instructions can have zero or one immediate value. Therefore, four up to eight words may have to be fetched each processor cycle. According to FIG. Sb after a reset only the instructions for the processing units of the first processor instruction are fetched. In FIG. 9 the so-called fetch window 330 is denoted by an empty frame. The instructions which are decoded are highlighted by a hatched frame 342. The instructions and immediate values which are fetched are highlighted by a contrarily hatched frame 344. The bar 340 highlights the part that is forwarded to the execution stage.

The lines 301-307 show the same instruction stream buffers which have the same processor instructions. The positions of the words are denoted by position indicators 300 for clearness. The instructions are executed from left to the right through both instruction line buffers 361 and 362. According to FIG. 7, when four processing units are used and each instruction for a processing unit can have zero or one immediate value, zero to four immediate values can be stored right after the instruction word group. Therefore, four instruction words can be followed by zero to four immediate words. In the example of FIG. 9 one can see that the first four instructions at positions 00-03 have three immediate words at positions 04-06. The next instruction words at positions 07-10 have one immediate word at position 11. The next four instructions at positions 12-15 have no immediate values assigned to them. The four instruction words at positions 16-19 have four immediate words at positions 20-23 and so on.

After a reset or a jump-miss to an address at the beginning of an instruction line the fetch window 330 can be set to the beginning of the instruction line buffer 361 and the four instructions at position 00-03 are fetched denoted by the frame 344. This situation is shown for a first processor cycle in the line 301 of FIG. 9. In some embodiments of the present disclosure the fetch window can have a length of four as shown in line 301 in FIG. 9. In other embodiments the fetch window can have a constant length as shown for all the lines 302 to 307. A fetch window can be implemented by a set of pointers which store the addresses of the words. To avoid additional effort and computations, some embodiments can copy the fetch window pointers of position 00-03 which point to the instruction words to the fetch window pointers which point to the immediate words or set them to a constant value.

Line 302 in FIG. 9 shows the actions that can be performed in a second processor cycle. The four instructions at positions 00-03 which could have been fetched in the cycle before are decoded which is denoted by the frame 342 and the fetch window 330 is extended to eight words and is shifted by four to the position 04-11. The fetch window denotes the area where the next instructions and the immediate values of previous instructions are fetched. In the example shown in line 302 in FIG. 9 only three of the four instruction words at positions 00-03 have immediate values. These three immediate values are at positions 04-06 and are fetched along with four next instructions at positions 07-10 and, hence, seven words of the fetch window are fetched (344). The decoded instruction words of positions 00-03 and the fetched immediate words of positions 04-06 are forwarded to the next stage which can be the forward stage 241 of the pipeline shown in FIG. 6.

Line 303 shows the actions that can be performed in a third processor cycle. The four instructions at positions 07-10 which could have been fetched in the cycle before are decoded which is denoted by the hatched frame 342 and the fetch window 330 is shifted by seven to the position 11-18. One of the four instruction words at positions 07-10 have an immediate value. This immediate value is at position 11 and is fetched along with four next instructions at positions 12-15 and, hence, five words of the fetch window are fetched which is denoted by the hatched frame 344 in line 303. The decoded instruction words of positions 07-10 and the fetched immediate word of position 11 are forwarded to the next stage which can be the forward stage 241 of the pipeline shown in FIG. 6.

Line 304 shows the actions that can be performed in a fourth processor cycle whereas the decoded instruction words have no immediate values. The four instructions at positions 12-15 which could have been fetched in the cycle before are decoded which is denoted by the hatched frame 342 and the fetch window 330 is shifted by five to the position 16-23. None of the four instruction words at positions 12-15 have an immediate value. The four next instructions at positions 16-19 are fetched and, hence, four words of the fetch window are fetched which is denoted by the hatched frame 344 in line 304. The decoded instruction words of positions 12-15 are forwarded (denoted by the bar 340) to the next stage which can be the forward stage 241 of the pipeline shown in FIG. 6.

In line 305 the four instructions at positions 16-19 which could have been fetched in the cycle before are decoded which is denoted by the hatched frame 342 and the fetch window 330 is shifted to the position 20-27. All four instruction words at positions 16-19 have an immediate value. These immediate values are at positions 20-23 and are fetched along with four next instructions at positions 24-27 and, hence, all eight words of the fetch window are fetched which is denoted by the hatched frame 344 in line 305. The decoded instruction words of positions 16-19 and the fetched immediate words of positions 20-23 are forwarded to the next stage.

The lines 306-307 are processed similar to line 302-305. The only difference is that the fetch window overlaps the second instruction line buffer 362. A logic which is not drawn has to take care that at least that part of the second instruction line which is inside the fetch window is completely loaded. In some cases—even in case of an instruction cache miss—it can be possible that the second instruction line buffer cannot be loaded until the fetch window runs into to buffer. In this case the processor can stall until that part of the instruction line buffer which is inside the fetch window is loaded. In other embodiments the processor can stall until the whole line buffer is filled.

As depicted above, an advantage of the present method and apparatus is that the tasks of fetching and decoding could be broken in small tasks which are fetching of instructions, fetching of immediate values, and decoding of the previously fetched instructions. Another advantage of the present method and apparatus is that in case of a jump-hit one cycle can be saved compared to conventional methods. As stated above, the scenario of FIG. 9 is the situation after a reset or the case of a jump-miss. A jump-miss is an undesirable situation in all processor architectures and requires many additional steps to be taken which are mostly beyond the scope of this disclosure. A jump-miss is a situation where the jump-target instruction is not loaded in the instruction cache. In other words, a jump-miss means that the processor jumps to an address which is not available in the instruction cache—a so-called cache-miss—and has to be loaded from the much slower external instruction memory which can take many clock cycles. As a result, the instruction line buffers cannot be loaded very fast which possibly causes the processor to stall. Such a scenario is extremely undesirable and, therefore, today's instruction caches use large memories and have sophisticated caching algorithms.

On contrary, a jump-hit means, that the jump-target is available in the cache—a so-called cache-hit—and the instructions at the new instruction address can be loaded within a few processor cycles. A jump-hit normally causes the processor—in the best case—to lose a few cycles as the jump-target has to be loaded first and the disclosed arrangements improve the time delays normally associated with a jump-hit.

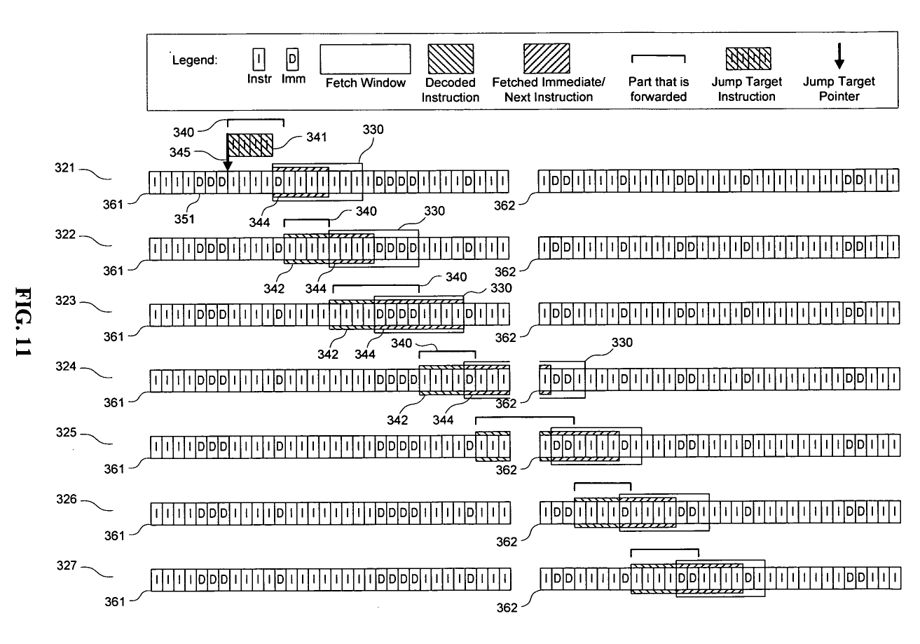

FIG. 10 shows a situation for a jump-miss, i.e., the jump-target was not in the cache. In this case, the instruction line buffers can be loaded from the external memory and the pipeline can continue processing once at least that part of the instruction line buffer is filled which is within the fetch window. The situation is similar to FIG. 9, which shows the scenario after a reset. In the case of FIG. 10 the processor jumps to the position indicated by the jump pointer 345. As the instructions line buffer in execution could not be read in time in case of a jump-miss, the processor starts fetching the next instruction according to time-step 0 in FIG. 5b. In FIG. 10 the fetch window 330 can be reduced for the initial fetch to a length of four and the four instruction words 344 are fetched in line 311.

The lines 312 to 317 shown in FIG. 10 are processed regularly as explained before. E.g., as the line buffers 361 and 362 are chosen the same for the examples shown in FIG. 9 and FIG. 10, lines 312 and following in FIG. 10 are exactly executed like the lines 303 and following in FIG. 9.

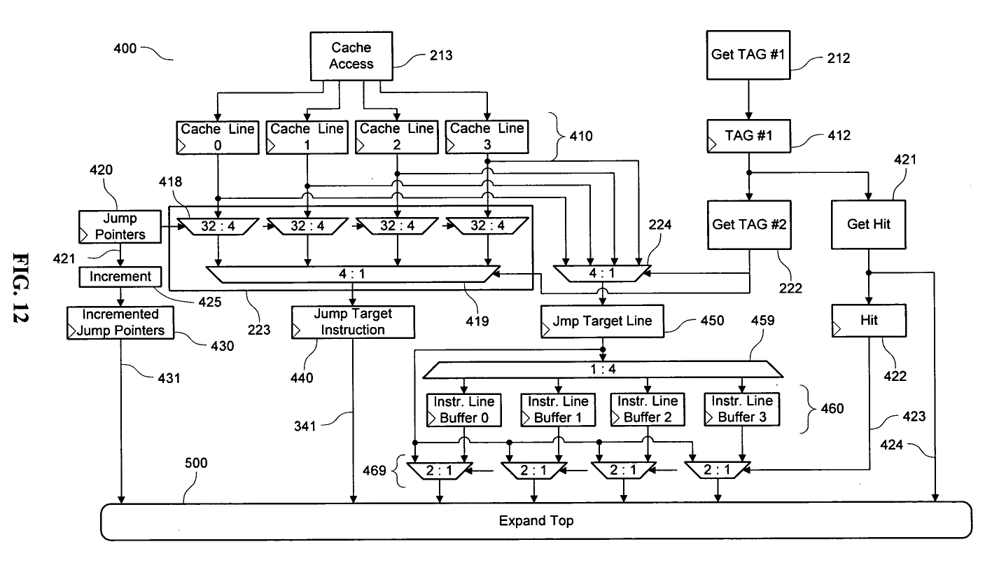

FIG. 11 shows the situation of FIG. 10 in case of a jump-hit. In both figures a jump to the same position is performed—a jump to the jump-target pointer 345. The lines 322-326 are identical to the lines 313-317. However, in case of a jump-hit as shown in FIG. 11, line 321 shows one benefit of the present method and apparatus. Line 321 can execute both lines 311 and 312 in one step in case of a jump-hit. As explained above, in case of a jump-hit the instruction line buffers can be directly loaded from an instruction cache system. However, the present method and apparatus exploits modifications in the instruction cache system, i.e., in the instruction stream buffer update module 221 of FIG. 4, that can allow to simultaneously load and update the instruction line buffers, e.g., 361, 362, 363, and/or 364, and to fetch the next instruction words 341 and to forward them to the fetch/decode stage 231 and 233.

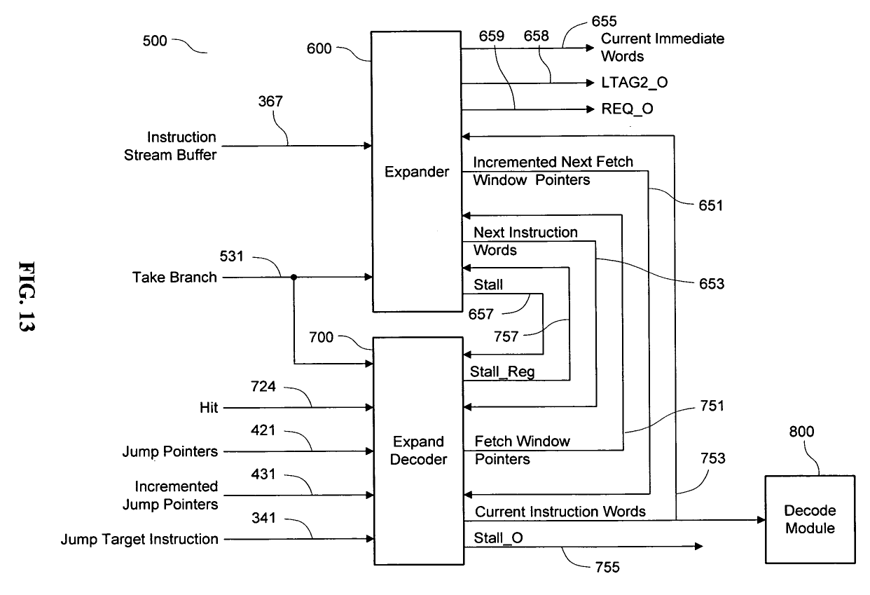

In the embodiment shown in FIG. 11, these instruction words 341 are at positions 07-10 and are fetched and bypassed directly to the decode stage 233 of FIG. 4 from the instruction cache system. The instruction words 341 are further called jump-target instructions. This can enable the pipeline architecture of FIG. 4 and FIG. 6 to win one cycle in case of a jump-hit and to decode the fetched jump-target instructions 341 which could have been extracted simultaneously from the instruction cache system. The reason why the jump-target instructions can be extracted with low effort from the instruction cache system and can be bypassed to the decoding stage is the usage of the special structure of the processor instruction shown in FIG. 7 in combination with the method of FIG. 5b and will be explained in more detail in FIG. 12: the extraction of jump-target instructions of a processor instruction arranged as shown in FIG. 7 directly from the instruction cache system can be performed with small effort which enables to extract and forward them within the same cycle to the next stage.

The instruction and immediate word fetch is performed similar to the lines 312 and 303 of FIG. 10 and FIG. 9, respectively. The fetch window 330 in line 321 of FIG. 11 is set to the position 11-18. One of the four jump-target instructions 341 at positions 07-10 have an immediate value. This immediate value is at position 11 and is fetched along with four next instructions at positions 12-15 and, hence, five words of the fetch window are fetched which is denoted by the hatched frame 344 in line 321. The decoded jump-target instructions 341 of positions 07-10 and the fetched immediate word of position 11 are forwarded to the next stage.

As discussed above, jump-misses can be handled by designing a sophisticated instruction cache system. One of the advantages of the current disclosure is that in the case of a jump-hit, i.e., the jump-target is in the cache, that one cycle can be saved compared to the conventional method of processing fetching and decoding which is illustrated in FIG. 5a. Conventional methods fetch the jump-target instructions. However, the apparatus and method of the present disclosure can fetch the next (second) instructions as the jump-target instructions could have been extracted from the instruction system and are bypassed to the decode stage. The current immediate words can be fetched together with the next instruction words and can be forwarded to the forward stage bypassing the decode stage.

As described, one of the advantages of the present method and apparatus is that in case of a jump-hit even one processor cycle is saved compared to conventional methods and compared to a jump-miss as shown in FIG. 11. Another advantage is that instructions and data values are neatly and clearly arranged. The logic to extract the jump-target instructions can be small and the logic to determine immediate values can be performed in a next cycle. Another advantage is that no decoding of immediate values occurs and the processes of fetching and decoding are reduced and simplified as outlined in FIG. 5b.

In the description an embodiment of the disclosure with four processing units and instruction words—one for each processing unit—has been presented. Each instruction word could have zero or one immediate words. However, it is to note, that the disclosure is not limited to any number of processing units or instruction words and other embodiments of the disclosure can use instruction words that each can have any number of immediate words. Moreover, in the description two instruction stream buffers 371 and 372 and two instruction line buffers per instruction stream buffers are used (see FIG. 8). However, the disclosure is not limited to any number or width of instruction stream buffers or instruction line buffers. Instead any number or widths or even different implementations of instruction stream buffers could be used.

The instruction cache system mentioned above is indicated in the pipeline of FIG. 4 by the stages 211 and 221 which use the registers C0 209, C1 219, and the fetch/decode register 229. FIG. 6 shows the same pipeline in a more detail. The request control module 237 can receive a jump request from the forward stage 241 and/or the execute stage 251. In other embodiments it can get a trigger of registers such as the forward register 239 or the execute register 249. In other embodiments other stages or registers may send signals and/or data to the request control module 237. The request control module 237 can request to load and fill instruction stream buffers or in other embodiments single instruction line buffers with the part of the code that contains the jump-target.

The modules 212, 213, 222, 223, and 224 denote the procedure of accessing the cache and updating pointers and instruction line buffers or instruction line buffers and are discussed in more detail in FIG. 12. The module 213 can be responsible to access the cache and to return cache-lines of an n-way associative instruction cache. The module “Get Tag” can be used to generate a signal to select the appropriate cache-line. The module “Get Tag” can need more time to generate the signal than it is available between two clock cycles and, hence, can be broken up into two modules 212 and 222. The module 223 can determine the jump-target instructions 341. The module 224 can update the instruction line buffers.

FIG. 12 shows the mentioned modules 212, 213, 222, 223, and 224 of FIG. 6 in more detail which are used for a jump-hit. The module 213 can access the instruction cache and can write the cache-lines to cache-line registers 410. In the embodiment of FIG. 12 a four-way associative cache has been used. The jump pointers 421 which can be stored in the jump pointers register 420 can be the addresses of each word within the fetch window 330. In the embodiment shown in FIG. 9, FIG. 10, and FIG. 11 the fetch window 330 can have eight jump pointers 421—one for each word. Four jump pointers of the jump pointers register 420 can be used to address the jump-target instructions 341 using a switching logic 418. For faster handling, the jump pointers 421 can be incremented by four 425 and stored in an incremented jump pointers register 430 which can output the incremented jump pointers 431.

The tag to select the appropriate cache-line register 410 can be computed by the “Get Tag” module which is broken up into two modules 212 and 222 in FIG. 12 for performance reasons since the computation of the tag could be too time consuming to be calculated in one step. The so computed tag of the module 222 can be used to control the switching logics 419 and 224 to select the appropriate cache-line register 410 and the jump-target instructions 341 can be stored in the jump-target instruction register 440 and the cache-line that contains the jump-target—called jump-target line which is the new instruction line—can be stored in a jump-target line register 450. The new instruction line can then be stored in one of the appropriate instruction line buffer 460 which can be one of the instruction line buffers 361, 362, 363, and 364 of FIG. 8. Two instruction line buffers can be grouped to an instruction stream buffer such as 371 or 372. The instruction line buffers 460, the jump-target instruction register 440, and the jump-target line 450 can be part of the fetch/decode register 229 of FIG. 6.

For a fast forwarding to the next stage the new instruction line can be bypassed (once it is available) to the next stage using a switching logic 469. The switching logic 469 can be controlled by a logic module or a register 421 and 422 which can determine whether the cache access 213 has been a hit. The incremented jump pointers 431, the jump-target instructions 341, and the new instruction line can be forwarded to the expand top module which can be an implementation of the fetch/decode stage 231 and 233 of FIG. 4. The path indicated by the modules 418, 419, 223, and 440 is called bypass path whereas the path denoted by the modules 450, 459, 460, and 469, can be called main path.

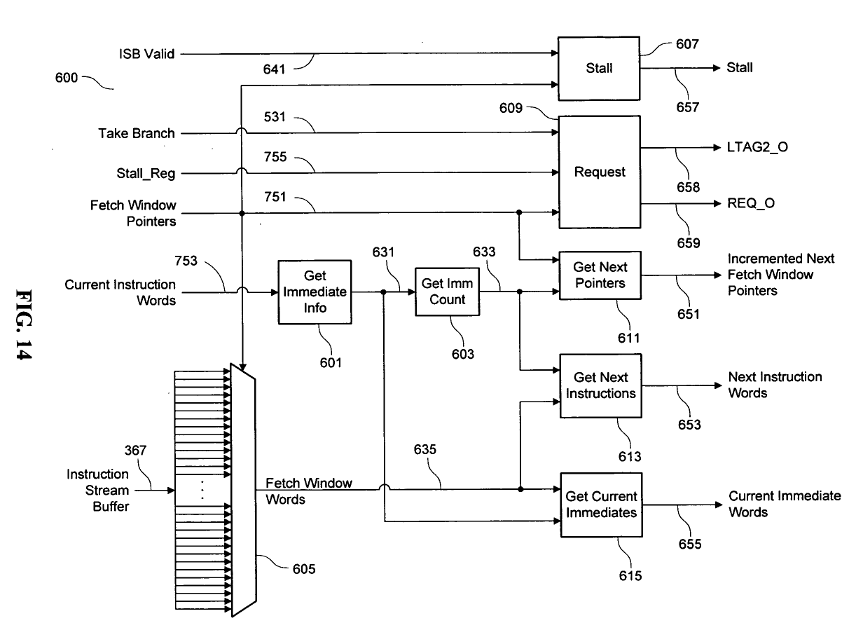

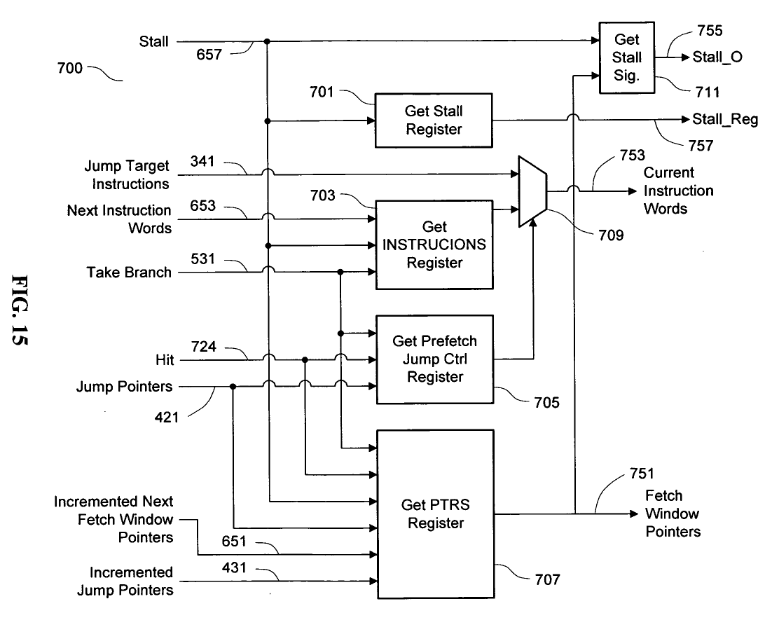

FIG. 13 shows an overview of an apparatus according to the present disclosure that can be used as an implementation of the fetch stage 231 of FIG. 4, the modules 232, 234, and/or 238 of FIG. 6, or the expand top module 500 of FIG. 12. FIG. 13 uses two modules—an expander 600 and an expand decoder 700—to calculate the fetch window 330 and to fetch the instructions and immediate values 344 of FIG. 9-FIG. 11. An embodiment of the expander module 600 is shown in FIG. 14 which can be used to fetch the current immediate values and the next instruction. The module 600 can forward the current immediate values to the next stage. The expand decoder module 700 is shown in FIG. 15 which can be used to send the current instruction to a decoder module such as the module 236 of FIG. 6.

In a regular program flow the current instruction words are decoded while the associated current immediate words and the next instruction words are fetched. This is shown, e.g., in the lines 302-307 of FIG. 9. According to FIG. 13 the module 700 can compute the current instruction words 753 and can forward them to a decoder module 800 and to the expander module 600. From these current instruction words 753 the module 601 of FIG. 14 can extract which of them require immediate values. As described above, to speed up the implementation for each word of the fetch window—the so called fetch window words - a separate pointer which can hold the address of the word can be used. These pointers are called fetch window pointers 751 which can be used to select the fetch window words 635 of the active instruction stream buffer 367 which are within the fetch window 330 of FIG. 9-FIG. 11 using a selection logic 605. Using the information determined by the module 601 which of the instructions need an immediate value and the fetch window words 635 the module 615 can select the current immediate words and forward them to the next stage.

The next instruction words 653 can be determined by the module 613 from the fetch window words 635 using the number of immediate words 633. As the current immediate words 655 of the current instruction words 753 are followed directly by the next instruction words (see also lines 301-307 of FIG. 9) the next instruction words 653 can be extracted from the fetch window words 635 by skipping the actual number of current immediate words whereas this number can be calculated by the module 603.

After extraction of the immediate words and the instruction words of the fetch window the fetch window pointers 751 have to be shifted by the actual number of current immediate words plus constantly four next instruction words which can be performed by the module 611.

The examples of FIG. 9 to FIG. 11 show another problem which has not been discussed in detail: when the fetch window has crossed the end of the first instruction line buffer and has gone into the second, the first instruction line buffer has to be loaded with the next data either from the instruction cache in case of a cache-hit or from the instruction memory in case of a cache-miss. Once the fetch window again has crossed the end of the second instruction line buffer and has gone again into the first, the second instruction line buffer has to be loaded. The according signals sent to the instruction cache can be computed by the module 609. The module 609 can take the fetch window pointers 751 to determine whether the fetch window crosses the border between two instruction line buffers to initiate an instruction line buffer reload. It also can take a signal 755 that tells whether the processor stalls and a signal “take branch” 531 that informs that a jump has been requested by external control logic. The module 609 can output a signal REQ_O 659 to request a line buffer reload and the index of the instruction line buffer 658.

The logic 607 can raise a stall signal 657 which can be signal the processor pipeline to stall if the fetch window approaches a line buffer or words of a line buffer which have not been reloaded yet. This could be the case in a cache-miss, e.g., when that part of the instruction line buffer which is within the fetch window could not have been finished. The signal 657 can be used within the module 500 to stall until at least those words of the instruction stream buffer which are within the fetch window are available. A validity signal 641 can tell the module 607 which words of the line buffers have already been updated.

The expand decoder module 700 of FIG. 15 can determine the current instruction words 753 which can be used by the expander module 600 of FIG. 14 to determine the current immediate words 655 and the next instruction words 653. The next instruction words 653 can be stored in a register of module 703. In case of regular program flow (no jump) the next instruction words 653 can be the current instruction words 753 in a next processor cycle which can be controlled by a get prefetch jump control register 705 using a switching logic 709. The get instructions register module 703 can also store the next instruction words 653 for several cycles in case of a stall signal 657. The hit signal 724 can be one of the signals 423 or 424 of FIG. 12.

In case of a jump-hit the expand decoder module 700 combined with the logic of 400 of FIG. 12 allows to save a cycle by bypassing and pre-fetching the jump-target instructions 341. In case of a jump-hit the said logic does not read the instruction words from the instruction line buffers. Instead, a separate logic performs the fetching: the jump-target instructions 341 are directly read from the instruction cache using a switching logic 418 and 419. The jump-target instructions 341 then can be applied to the module 700 which can bypass the jump-target instruction 341 using a switching logic 709. In the special case of a jump-hit, this mechanism saves one clock cycle as described before. The special arrangement of the switching logics 418 and 419 within the block 223 in FIG. 12 is advantageous and efficient and allows to be processed in parallel to the computations with the module 222 which can determine which of the cache-lines has to be selected. It is to note that in other embodiments the switching logics 418 and 419 can be exchanged, i.e., the logic 419 would then select the appropriate cache-line first and the jump-target instructions would then be extracted thereof using another switching logic which, however, would lead to much more complex logic elements as the cache-lines normally are very wide.

The module 707 can be used to choose the correct fetch window pointers 751 for the next cycle among the jump pointers 421, the incremented next fetch window pointers 651, and the incremented jump pointers 431. The incremented next fetch window pointers 651 could have been calculated by the module 600 and point to the next fetch window in a regular program flow (no jump). The jump pointers 421 denote the position of the fetch window 751 at a jump-miss (compare FIG. 10) or after a reset. The incremented jump pointers 431 describe the fetch window at a jump-hit (compare FIG. 11).

The module 711 in FIG. 15 can produce a stall signal Stall_O 755 which can cause subsequent stages to the fetch stage to stall. This can be the case in a jump-miss which is illustrated in FIG. 10 when the instruction words of the new instructions have to be fetched.

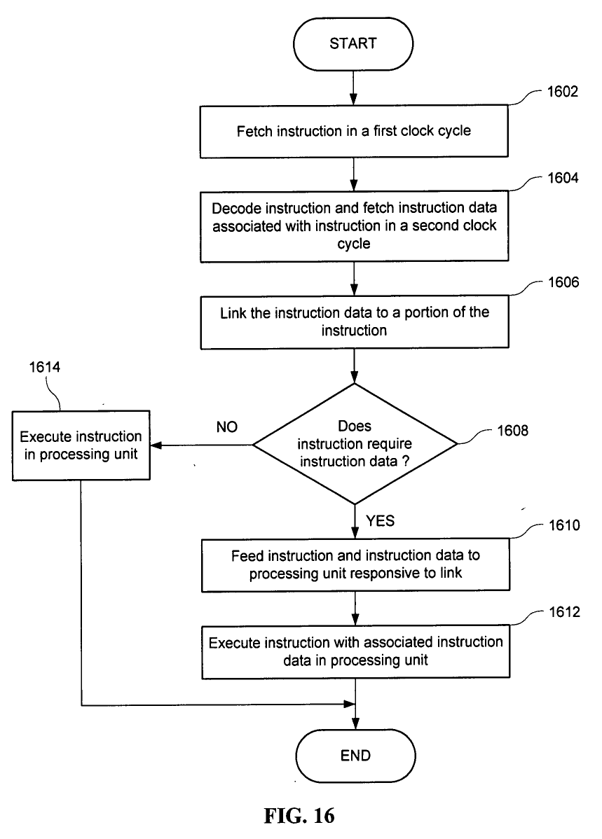

FIG. 16 is a flow diagram of a method for offset fetching and decoding of instructions and data. As illustrated by block 1602, instructions can be fetched in a first clock cycle. In a second clock cycle these instructions can be decoded while the instruction data associated to the instructions can be simultaneously fetched as illustrated by block 1604. As illustrated by block 1606, the instruction data can be linked to the corresponding instructions. At decision block 1608, it can be determined if an instruction requires data. When instruction data is required to execute an instruction, the instruction is fed with the associated instruction data to the processing unit responsive to the link which is illustrated by block 1610. As illustrated by block 1612, the instructions are executed in the assigned processing unit with their associated instruction data. However, in case an instruction does not require instruction data, the instructions are executed in the corresponding processing unit as illustrated by block 1614.

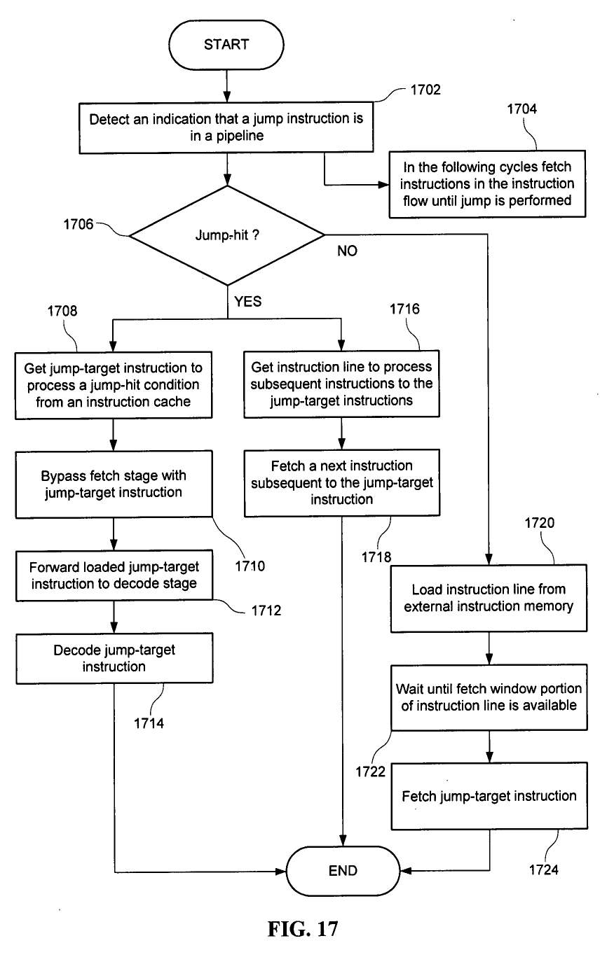

FIG. 17 shows a flow diagram for handling a jump-hit condition. As illustrated by block 1702, a jump instruction can be detected by a module within a processing pipeline. In one embodiment the module can be a stage prior to the execute stage or in other embodiments part of the execute stage. As illustrated by block 1704, in some embodiments of the disclosure in subsequent cycles the instructions succeeding the jump instruction can be fetched and fed to subsequent stages until the jump actually is performed.

At decision block 1706, it can be determined whether the jump was a jump-hit or not. In case a jump-hit is detected both paths starting at blocks 1708 and 1716 can be processed in parallel. The path starting at module 1716 can be called main-path and the path starting at module 1708 can be called a bypass path. As indicated by block 1708, the jump-target instruction can be loaded from an instruction cache. As indicated by block 1710 the loaded jump-target instruction can be handled in a way to bypass the fetch stage. As indicated by block 1712 the bypassed jump-target instruction can be forwarded to a decode stage and decoded in a further step as illustrated by block 1714.

In the main path, the whole instruction line can be loaded from the instruction cache which can contain the jump-target instruction and instructions subsequent to the jump target instruction which is illustrated by block 1716. As illustrated by block 1718 the instruction subsequent to the jump-target instruction can be fetched by the fetch stage.

However, in case a jump-miss has been detected at decision block 1706, the instruction line cannot be loaded from the instruction cache. Instead, the instruction line can be loaded from an external instruction memory which is illustrated by block 1720. As illustrated by block 1722 the fetch stage (and in one embodiment all subsequent pipeline stages) can wait until at least the fetch window portion of the instruction line is loaded. In other embodiments of the disclosure not only the fetch window but even the whole instruction line can be requested to continue processing. As illustrated by block 1724, the jump target can be fetched by the fetch stage from the instruction line once at least a fetch window portion is available.

Each process disclosed herein can be implemented with a software program. The software programs described herein may be operated on any type of computer, such as personal computer, server, etc. Any programs may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet, intranet or other networks. Such signal-bearing media, when carrying computer-readable instructions that direct the functions of the present disclosure, represent embodiments of the present disclosure.

The disclosed embodiments can take the form of an entirely hardware embodiment, an entirely software embodiment or an embodiment containing both hardware and software elements. In one embodiment, the arrangements can be implemented in software, which includes but is not limited to firmware, resident software, microcode, etc. Furthermore, the disclosure can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The control module can retrieve instructions from an electronic storage medium. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. A data processing system suitable for storing and/or executing program code can include at least one processor, logic, or a state machine coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be apparent to those skilled in the art having the benefit of this disclosure that the present disclosure contemplates methods, systems, and media that can improve pipelines processing. It is understood that the form of the arrangements shown and described in the detailed description and the drawings are to be taken merely as examples. It is intended that the following claims be interpreted broadly to embrace all the variations of the example embodiments disclosed.

What is claimed is:

1. A method comprising:
determining that a jump instruction is loaded in a main path of a processing pipeline prior to the jump instruction being executed;
loading a jump hit target instruction in a bypass path of the pipeline in response to the determining that the jump instruction is loaded in the main path, the bypass path bypassing at least one stage of the processing pipeline and coupling into the main path in a stage that is prior to the execute stage; and
switching the jump hit target instruction into the main path in response to a successful jump-hit condition.

2. The method of claim 1 further comprising fetching instruction data associated with the jump instruction and bypassing a decode stage with the instruction data.

3. The method of claim 1, wherein the bypass path bypasses a fetch stage.

4. The method of claim 1, wherein an existence of the loaded jump instruction is determined in a forward stage.

5. The method of claim 1, wherein the bypass path and the main path are clocked concurrently.

6. The method of claim 1, wherein the jump-target instruction is executed in response to an occurrence of a jump-hit.

7. The method of claim 1, wherein the coupling into the main path comprises coupling into a forward stage.

8. The method of claim 1, wherein the coupling into the main path comprises coupling into an execute stage.

9. An apparatus comprising:
a fetch module to fetch an instruction to a pipeline;
a decode module coupled to the fetch module to decode the instruction;
an execute module coupled to the decode module to execute the instruction;
a jump instruction detector to detect a jump condition in the pipeline prior to the jump instruction being executed; and
a jump instruction fetch module to retrieve and load a jump-hit instruction in response to the jump instruction detector, the jump instruction fetch module to move the jump fetch instruction to a middle stage of the pipeline, bypassing stages in the pipeline.

10. The apparatus of claim 9, further comprising a forward module coupled to the execute module to control an input to the execute module.

11. The apparatus of claim 9, further comprising a switch to switch the jump-hit instruction into the pipeline.

12. The apparatus of claim 11, wherein the switch loads the instructions into a forward stage in response to a successful jump-hit.

13. The apparatus of claim 9, wherein the jump-hit instruction is loaded directly to the execute stage after a successful jump-hit occurs.

14. The apparatus of claim 9, wherein the jump-hit instruction bypasses the fetch module.

15. The apparatus of claim 9, further comprising a fetch stage to fetch instruction data associated with the jump instruction wherein the instruction data bypasses the decode stage.

16. A computer program product comprising a computer useable medium having a computer readable program, wherein the computer readable program when executed on a computer causes the computer to:
determine that a jump instruction is loaded in a main path of a processing pipeline prior to the jump instruction being executed;
load a jump hit target instruction in a bypass path of the pipeline in response to the determining that the jump instruction is loaded in the main path, the bypass path bypassing at least one stage of the processing pipeline and coupling into the main path in a stage that is prior to the execute stage; and
switch the jump hit target instruction into the main path in response to a successful jump-hit condition.

17. The computer program product of claim 16, further comprising a computer readable program when executed on a computer causes the computer to load the instructions into a forwarding stage in response to a successful jump-hit.

18. The computer program product of claim 16, further comprising a computer readable program when executed on a computer causes the computer to load the instruction to an execute stage in response to a successful jump-hit.

19. The computer program product of claim 16, further comprising a computer readable program when executed on a computer causes the computer to fetch instruction data associated with the jump instruction and bypass a fetch stage with the instruction data.

20. The computer program product of claim 16, further comprising a computer readable program when executed on a computer, causes the computer to determine a jump instruction in the pipeline prior to the jump condition being executed by the execute stage.
